(19) United States
(12) Patent Application Publication
(10) Pub. No.: US 2015/0109473 A1
(43) Pub. Date: Apr. 23, 2015

(54) PROGRAMMING A CAMERA SENSOR

(71) Applicant: NVIDIA Corporation, Santa Clara, CA (US)

(72) Inventors: Jihoon BANG, Fremont, CA (US); Bhushan RAYRIKAR, Sunnyvale, CA (US); Shiva DUBEY, San Jose, CA (US)

(73) Assignee: NVIDIA CORPORATION, Santa Clara, CA (US)

(21) Appl. No.: 14/060,876

(22) Filed: Oct. 23, 2013

(51) Int. Cl. H04N 5/232

(52) U.S. Cl. CPC H04N 5/23229; H04N 5/23293
USPC 348/222.1

(57) ABSTRACT

One embodiment of the present invention sets forth a method for performing camera startup operations substantially in parallel. The method includes programming graphics hardware to perform one or more processing functions for a camera. The method also includes allocating resources for one or more camera operations. The method also includes programming the camera sensor to capture an image and initiating a preview of the image on a display associated with the camera. Finally, the steps of allocating resources and programming the camera sensor are performed substantially in parallel. One advantage of the disclosed technique is that the launch time for the camera is reduced. This allows a user to take a picture more quickly and thus improves the user experience.

### BACKGROUND OF THE INVENTION

1. Field of the Invention

Embodiments of the present invention relate generally to camera sensors and, more specifically, to a technique for programming a camera sensor to improve startup time.

2. Description of the Related Art

Some portable devices, such as a cell phone or tablet device, typically include one or more cameras. When a user wants to take a picture, the user generally performs an action to launch a camera application (or camera module), such as selecting an icon on a display or pressing a button on the device. In a conventional approach, once the camera application is launched, a startup pipeline is commenced. In the startup pipeline, resources are allocated and a camera sensor is programmed. Performing the operations in the startup pipeline in serial can cause a noticeable delay. In addition, stages in the startup pipeline that are dependent on the programming of the camera sensor are delayed.

One problem with the conventional startup approach described above is that the user may miss a photographic moment that the user wishes to capture while waiting for the camera application to launch. Even a delay of less than one second can result in a poor user experience when trying to quickly take a picture.

Accordingly, what is needed in the art is an improved technique for programming a camera sensor to improve camera startup time.

### SUMMARY OF THE INVENTION

One embodiment of the present invention sets forth a method for performing camera startup operations substantially in parallel. The method includes programming graphics hardware to perform one or more processing functions for a camera. The method also includes allocating resources for one or more camera operations. The method also includes programming the camera sensor to capture an image and initiating a preview of the image on a display associated with the camera. Finally, the steps of allocating resources and programming the camera sensor are performed substantially in parallel.

One advantage of the disclosed technique is that the launch time for the camera is reduced. This allows a user to take a picture more quickly and thus improves the user experience.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 illustrates a block diagram of an conventional pipeline for programming a camera sensor;

FIG. 4 illustrates a block diagram of an improved pipeline for programming a camera sensor, according to one embodiment of the present invention;

FIG. 5 illustrates a conceptual block diagram of a system for performing camera startup operations substantially in parallel, according to one embodiment of the present invention; and

FIG. 6 is a flow diagram of method steps for performing camera startup operations substantially in parallel, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

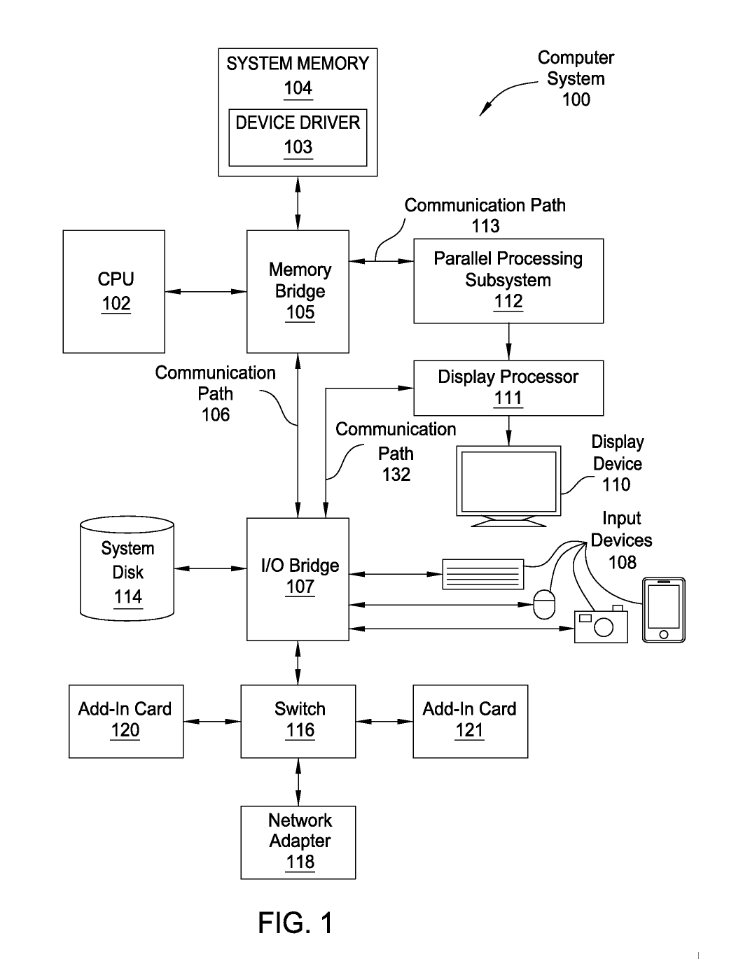

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard, a mouse, and/or a camera and forward the input information to CPU 102 for processing via communication path 106 and memory bridge 105. I/O bridge 107 also may be configured to receive information from an input device 108, such as a camera, and forward the information to a display processor 111 for processing via communication path 132. In addition, I/O bridge 107 may be configured to receive information, such as synchronization signals, from the display processor 111 and forward the information to an input device 108, such as a camera, via communication path 132. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

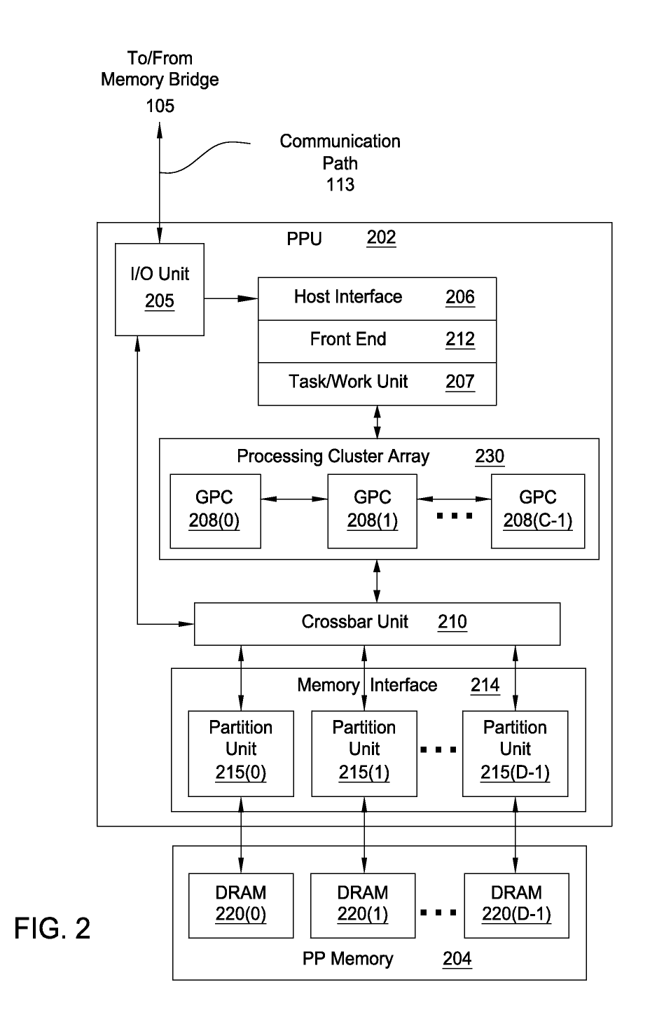

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with the, memory bridge 105, I/O bridge 107, display processor 111, and/or other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Programming a Camera Sensor

In the context of this disclosure, components of computer system 100 shown in FIG. 1 and PPU 202 shown in FIG. 2 may be included within a mobile computing device, such as a cell phone or tablet computer. In addition, certain elements of computer system 100 may be incorporated into an SoC, including CPU 102 of FIG. 1 and PPU 202 of FIG. 2, among other elements.

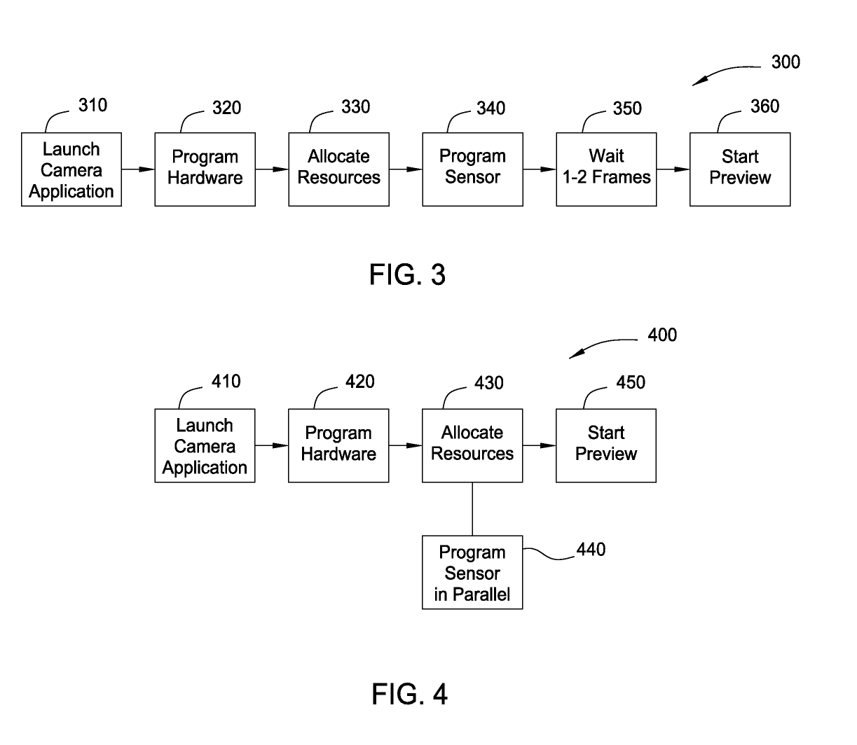

Camera sensors typically comprise a CCD image sensor or a CMOS sensor. As noted above, programming a camera sensor (also known as an image sensor) takes time, and a relatively long delay before a user can take a picture can create a poor user experience. FIG. 3 illustrates a block diagram 300 of a conventional pipeline for programming a camera sensor. First, in functional block 310, the camera application is launched. A camera application can be launched by a user selecting an icon or pressing a button on a cell phone, for example. In functional block 320, hardware is programmed. This can involve, in some embodiments, programming graphics hardware to handle the resolution of the camera sensor. The hardware may have one or more registers that are programmed to match a default resolution associated with the camera sensor. In other embodiments the hardware may be programmed with the resolution that was used by the camera application the previous time the camera was operated. Any suitable technique may be used to program the hardware to prepare for the operation of the camera.

In functional block 330, resources are allocated. Allocating resources can involve allocating memory that will be used by the camera. The memory allocated may depend on the size of a frame used by the camera and/or on other factors. In functional block 340, the camera sensor is programmed. Once the sensor is programmed, functional block 350 involves waiting a small number of frames for the exposure to take effect. In some embodiments the wait is 1 or 2 frames. In functional block 360, a preview of an image is commenced and the camera is ready for use.

As seen in the conventional pipeline, the actions required to launch the camera are performed in serial. Each action is substantially completed before the next action begins. Therefore the total amount of time required to launch the camera comprises approximately the sum of the times required to complete each separate action.

With the use of a parallel processing unit (or multi-core processor), some actions in the camera launch pipeline can be performed substantially in parallel, which reduces the time required to launch the camera. Performing actions substantially in parallel is illustrated in an improved pipeline in FIG. 4.

FIG. 4 illustrates a block diagram 400 of an improved pipeline for programming a camera sensor, according to one embodiment of the present invention. The camera sensor may be located in a cell phone or tablet device in some embodiments. First, in functional block 410, the camera application is launched. A camera application can be launched by a user selecting an icon or pressing a button, for example. The user could utilize an input device 108 as illustrated in FIG. 1, such as a cell phone. In functional block 420, hardware is programmed. Programming hardware can involve, in some embodiments, programming graphics hardware to handle the resolution of the camera sensor, as described above with respect to FIG. 3. Components in FIGS. 1 and 2 above can perform operations for programming hardware in functional block 420, such as CPU 102 or PPU 202.

In functional block 430, resources are allocated. Allocating resources can involve allocating memory that will be used by the camera, such as memory in system disk 114 as illustrated in FIG. 1. In some camera launch pipelines, allocating resources is one of the most time-consuming steps. In addition, with the use of a parallel processing unit (as illustrated above with PPU 202 in FIG. 2), one or more of the other steps of the launch pipeline may be performed substantially in parallel with allocating resources. Therefore a camera launch pipeline can be improved, and the camera launch time can be reduced, by performing one or more actions substantially in parallel with the step of allocating resources.

In functional block 440 of the improved pipeline illustrated in FIG. 4, the camera sensor is programmed substantially in parallel with allocating resources in functional block 430. In this embodiment, tasks that are dependent on the camera sensor programming can also be performed substantially in parallel with resources being allocated. For example, waiting for the exposure to take effect may also be performed substantially in parallel with allocating resources in functional block 430. Finally, in functional block 450, a preview of an image is started and the camera is ready for use. The preview of the image can be displayed on the display of a cell phone in one example embodiment.

In conclusion, a comparison of the pipelines shown in FIG. 3 and FIG. 4 illustrates how the time to launch the camera application can be reduced by performing two or more operations substantially in parallel.

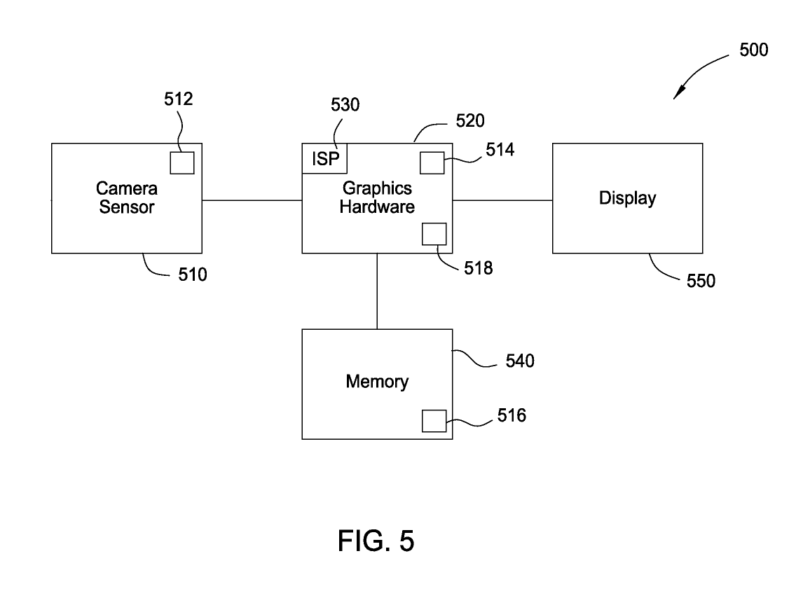

FIG. 5 illustrates a conceptual block diagram 500 of a system for performing camera startup operations substantially in parallel, according to one embodiment of the present invention. One or more software or logic components can perform the operations described in FIG. 5. These software or logic components can be stored in any appropriate memory illustrated in FIGS. 1 and 2 and can utilize any appropriate hardware illustrated in FIGS. 1 and 2 in this example embodiment.

Camera sensor 510 comprises any suitable camera sensor. In some embodiments camera sensor 510 is located in an input device 108 as illustrated in FIG. 1, where the input device 108 may be a cell phone. Sensor programming logic 512 programs the camera sensor. Sensor programming logic 512 may comprise any suitable software or logic operable to perform the steps involved in programming the camera sensor. In some example embodiments, sensor programming logic 512 may be application software, operating system software, or camera sensor logic. In some embodiments, programming the camera sensor involves setting one or more values in a register associated with the sensor to set the camera settings (such as the type of frame, image configurations, etc.).

Graphics hardware 520 comprises a parallel processing unit as described above in FIGS. 1 and 2. Programming hardware operations, as described in FIG. 4, occur in graphics hardware 520. Programming hardware involves, in part, setting up the hardware to handle the resolution of the camera sensor. Hardware programming logic 514 performs the operations involved in programming the hardware 520. Hardware programming logic 514 may comprise application software, operating system software, or any other appropriate software or logic to perform the programming operations. Hardware programming logic 514 may program settings in one or more registers to facilitate proper operation with the camera sensor settings. In this example embodiment, graphics hardware 520 also implements an Image Signal Processor (ISP 530) to communicate with camera sensor 510. ISP 530 is a specialized processor that can perform operations on image data received from the camera sensor 510.

Memory 540 is used for allocating resources as illustrated in FIGS. 3 and 4. The amount of memory that is allocated can depend on the size of a frame used by the camera and/or on other factors. Allocation logic 516 performs the operations for allocating resources in this embodiment. Allocation logic 516 may comprise application software, operating system software, or any other appropriate software or logic to perform the allocation operations.

Display 550 comprises any suitable display, and is operable to display camera images. Display logic 518 performs the operations for displaying an image, including a preview image for the camera.

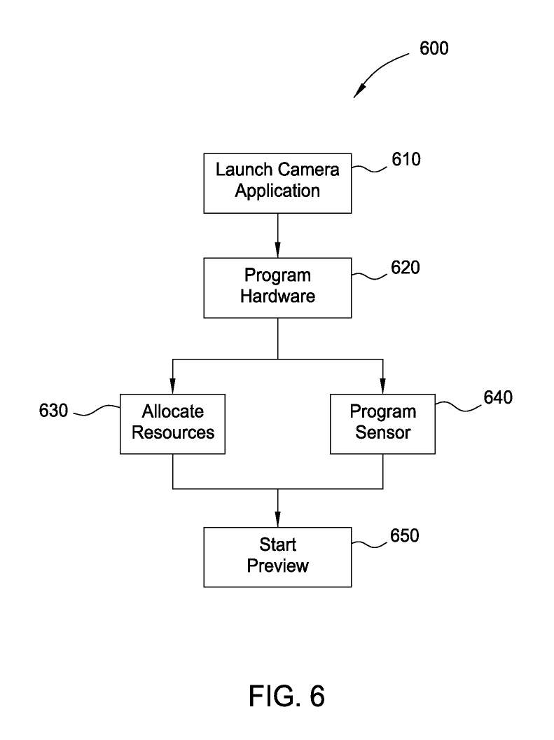

FIG. 6 is a flow diagram of method steps for performing camera startup operations substantially in parallel, according to one embodiment of the present invention. Although the method steps are described in conjunction with FIGS. 1-2 and 4-5, persons skilled in the art will understand that any system configured to perform the method steps, in any order, falls within the scope of the present invention. The logic and/or software described above in FIG. 5 can perform the steps in FIG. 6.

As shown, a method 600 begins in step 610, where a user launches a camera application. In some embodiments, a user can launch the camera application by pressing an icon on a touch-screen display or by pressing a button associated with a camera device.

In step 620, hardware programming logic 514 sets up registers in the graphics hardware to prepare the graphics hardware to operate properly with the camera sensor. In one example, settings in the registers are programmed to match the camera sensor settings.

In step 630, allocation logic 516 allocates resources for use with camera operations. In this example embodiment, allocating resources comprises allocating memory for storing data output by the camera sensor. In other embodiments, the resources could be allocated by operating system software, camera application software, or any other appropriate logic or software.

In step 640, sensor programming logic 512 programs the camera sensor substantially in parallel with step 630. Camera sensor programming may include programming specific values into registers associated with the camera sensor. These settings can notify the camera sensor of the type of frame or notify the camera sensor of other image settings. The camera sensor could be programmed by operating system software, camera application software, or any other appropriate logic or camera sensor programming software. In a system that utilizes parallel processing units, operations associated with step 630 can be performed by a first processor and operations associated with step 640 can be performed by a second processor. Camera application software, sensor programming logic, or other appropriate logic or software can establish the exposure substantially in parallel with step 630, which may involve waiting a small number of frames for the exposure to take effect.

When both step 630 and step 640 are complete, the camera is ready for use and the process proceeds to step 650, where display logic 518, camera application software, and/or operating system software previews the image captured by the camera and displays the image on a display.

In sum, logic and/or software is used to program a camera sensor substantially in parallel with allocating resources. A computing device may include a parallel processing unit that allows for two or more processes to be completed substantially in parallel, thus reducing the time required to program the camera sensor. The circuit, logic, and algorithms described above may be used to program the camera sensor substantially in parallel with allocating resources for use by the camera. Using embodiments of the present invention to perform startup operations substantially in parallel solves an issue with existing solutions for programming a camera sensor.

One advantage of the systems and techniques disclosed herein is that the launch time for the camera is reduced. This allows a user to take a picture more quickly and thus improves the user experience.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A method for programming a camera sensor, comprising:
programming graphics hardware to perform one or more processing functions for a camera;
allocating resources for one or more camera operations;
programming the camera sensor to capture an image; and
initiating a preview of the image on a display associated with the camera,
wherein the steps of allocating resources and programming the camera sensor are performed substantially in parallel.

2. The method of claim 1, wherein programming graphics hardware comprises configuring the graphics hardware to recognize a resolution of the camera sensor.

3. The method of claim 2, wherein the resolution of the camera sensor comprises a default resolution.

4. The method of claim 2, wherein the resolution of the camera sensor comprises the most recent resolution implemented by the camera in operation.

5. The method of claim 1, wherein allocating resources comprises allocating memory to store one or more images generated with the camera.

6. The method of claim 1, further comprising establishing an exposure for the camera sensor substantially in parallel with allocating resources.

7. The method of claim 1, wherein the graphics hardware comprises a first processor and a second processor configured to operate substantially in parallel, wherein the first processor performs the step of allocating resources, and the second processor performs the step of programming the camera sensor.

8. The method of claim 1, wherein the graphics hardware is configured to communicate with the camera sensor through an image signal processor (ISP).

9. A non-transitory computer-readable medium including instructions that, when executed by a processor, cause the processor to perform the steps of:
programming graphics hardware to perform one or more processing functions for a camera;
allocating resources for one or more camera operations;
programming a camera sensor to capture an image; and
initiating a preview of the image on a display associated with the camera,
wherein the steps of allocating resources and programming the camera sensor are performed substantially in parallel.

10. The non-transitory computer-readable medium of claim 9, wherein programming graphics hardware comprises configuring the graphics hardware to recognize a resolution of the camera sensor.

11. The non-transitory computer-readable medium of claim 10, wherein the resolution of the camera sensor comprises a default resolution.

12. The non-transitory computer-readable medium of claim 10, wherein the resolution of the camera sensor comprises the most recent resolution implemented by the camera in operation.

13. The non-transitory computer-readable medium of claim 9, wherein allocating resources comprises allocating memory to store one or more images generated with the camera.

14. The non-transitory computer-readable medium of claim 9, further comprising establishing an exposure for the camera sensor substantially in parallel with allocating resources.

15. The non-transitory computer-readable medium of claim 9, wherein the graphics hardware comprises a first processor and a second processor configured to operate substantially in parallel, wherein the first processor performs the step of allocating resources, and the second processor performs the step of programming the camera sensor.

16. A computing device, comprising:
a memory; and
a processing unit coupled to the memory and including:
a subsystem configured for programming a camera sensor for the computing device, the subsystem having:
graphics hardware operable to perform one or more processing functions for a camera;
allocation logic operable to allocate resources for one or more camera operations;
sensor programming logic operable to program the camera sensor to capture an image; and
display logic operable to initiate a preview of an image on a display associated with the camera,
wherein the steps of allocating resources and programming the camera sensor are performed substantially in parallel.

17. The computing device of claim 16, wherein the graphics hardware is configured to recognize a resolution of the camera sensor.

18. The computing device of claim 16, wherein allocating resources comprises allocating memory to store one or more images generated with the camera.

19. The computing device of claim 16, wherein camera application software establishes an exposure for the camera substantially in parallel with allocating resources.

20. The computing device of claim 16, wherein the graphics hardware comprises a first processor and a second processor configured to operate substantially in parallel, wherein the first processor performs the step of allocating resources, and the second processor performs the step of programming the camera sensor.
